(19) United States
(12) Patent Application Publication
(10) Pub. No.: US 2004/0229590 A1
(43) Pub. Date: Nov. 18, 2004

(54) Radio receiver

(75) Inventors: Shunichi Kubo, Tokyo (JP); Kazumi Sato, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/790,010

(22) Filed: Mar. 2, 2004

(30) Foreign Application Priority Data
Mar. 25, 2003 (JP) 2003-083134

(51) Int. Cl. H04B 1/10; H04M 1/00; H04B 1/38

(52) U.S. Cl. 455/307; 455/296

(57) ABSTRACT

A radio receiver unit which permits the electric power to be consumed in decreased amounts by a filter that suppresses the interference waves yet maintaining a quality of reception. The radio receiver unit has a FIR filter 16 for removing interference waves in a stage succeeding a receiving circuit unit 11 that receives RF signals containing desired waves and interference waves, and includes an interference wave power estimating unit 20 for estimating the magnitude of electric power of interference waves from the signal power measured by power measuring units 18, 19 and input to, and output from, the filter 16. When the estimated value of interference wave power is smaller than a threshold value, a control unit 21 turns the FIR filter 16 off.

### BACKGROUND OF THE INVENTION

1. Field of the Invention

This invention relates to a wireless receiver unit used for a radio communication system such as a wireless LAN. More specifically, the invention relates to a radio receiver unit having a filter for removing interference waves from the received signals that contain desired waves as well as undesired interference waves.

2. Description of the Related Art

In general, signals received by a radio receiver unit for radio communication contain desired waves and often interference waves that are factors of deteriorating the reception characteristics. An example of the radio receiver unit through which the interference waves infiltrate into the received signals can be represented by a wireless terminal that is used in a wireless LAN (local area network).

In a wireless LAN specified by, for example, IEEE 802.11a, an OFDM (orthogonal frequency-division multiplexing) is employed as a carrier modulation system, and channels assigned to access points which are the base stations are neighboring one another on a frequency axis maintaining an interval of 20 MHz. If viewed from a wireless terminal communicating with a particular access point, therefore, the situation is often such that there have been used neighboring channels having, as center frequencies, frequencies separated apart by 20 MHz from the center frequency of the desired receiving channel.

Thus, when channels neighboring the channel used by a first wireless terminal communicating with a first access point, are being used by a second access point or by a second wireless terminal communicating therewith, signals of the neighboring channels transmitted from the second access point or from the second wireless terminal infiltrate as interference waves into the signals received by the first wireless terminal to deteriorate the reception characteristics.

In order to avoid this problem in a radio receiver unit such as wireless terminal in a wireless LAN, an analog filter or a digital filter is used to suppress the signal power of interference waves infiltrating into the received signals based on a prerequisite of the presence of interference waves. As a filter having such a role, there can be exemplified an FIR filter (Finite Impulse Response filter) arranged in a stage succeeding an A/D converter that converts the received signals into digital signals. The radio receiver units using the FIR filter have been disclosed in, for example, JP-A-2000-269785.

The FIR filter includes a shift register having a plurality of taps, a multiplier for multiplying output tap coefficients of the taps, and an adder, and consumes a relatively large amount of electric power among the elements constituting the radio receiver unit. Therefore, operating the filters such as FIR filters at all times during the communication is not desirable from the standpoint of decreasing the consumption of electric power.

The wireless terminal for the wireless LAN is provided in the form of a wireless LAN card being mounted on, for example, a notebook personal computer. When being carried, this computer is powered by a battery and, hence, it is strongly desired to lower the consumption of electric power.

### SUMMARY OF THE INVENTION

It is an object of this invention to provide a radio receiver unit which permits the electric power to be consumed in decreased amounts by a filter that suppresses the interference waves yet maintaining a quality of reception.

In order to solve the above-mentioned problems, a radio receiver unit according to an embodiment of the present invention comprises receiving means for receiving RF signals that contain desired waves and interference waves, a filter arranged in a stage succeeding the receiving means and is capable of being turned on or off for removing interference waves, estimating means for estimating the magnitude of electric power of interference waves and for producing an estimated value that corresponds to the magnitude, and control means for turning the filter off during a period in which the estimated value is smaller than a threshold value. Provision may be further made of selection means for selecting either first received signals prior to passing through the filter or second received signals after having passed through the filter, whereby the filter is turned off by control means during a period in which the estimated value of the interference wave power is smaller than a threshold value to thereby control the selection means so as to select the first received signals.

Another embodiment of the invention is concerned with a radio receiver unit capable of changing the operation mode over to a normal power consumption mode or to a low power consumption mode, comprising receiving means for receiving RF signals that contain desired waves, a filter for removing interference waves arranged in a stage succeeding the receiving means and is capable of being turned on or off, and control means for turning the filter off during the low power consumption mode. Provision may be further made of selection means for selecting either first received signals of prior to passing through the filter or second received signals after having passed through the filter, whereby the filter is turned off by control means during the low power consumption mode to thereby control the selection means so as to select the first received signals.

### BRIEF DESCRIPTION OF THE DRAWINGS

FIG. 1 is a block diagram illustrating the constitution of a radio receiver unit according to a first embodiment of the invention;

FIG. 2 is a block diagram illustrating a concrete constitution of an FIR filter;

FIG. 3 is a diagram schematically illustrating the constitution of a wireless LAN;

FIG. 4 is a block diagram illustrating the constitution of the radio receiver unit according to a second embodiment of the invention; and

FIG. 5 is a block diagram illustrating the constitution of the radio receiver unit according to a third embodiment of the invention.

### DESCRIPTION OF THE PREFERRED EMBODIMENTS

Embodiments of the invention will now be described with reference to the drawings.

### First Embodiment

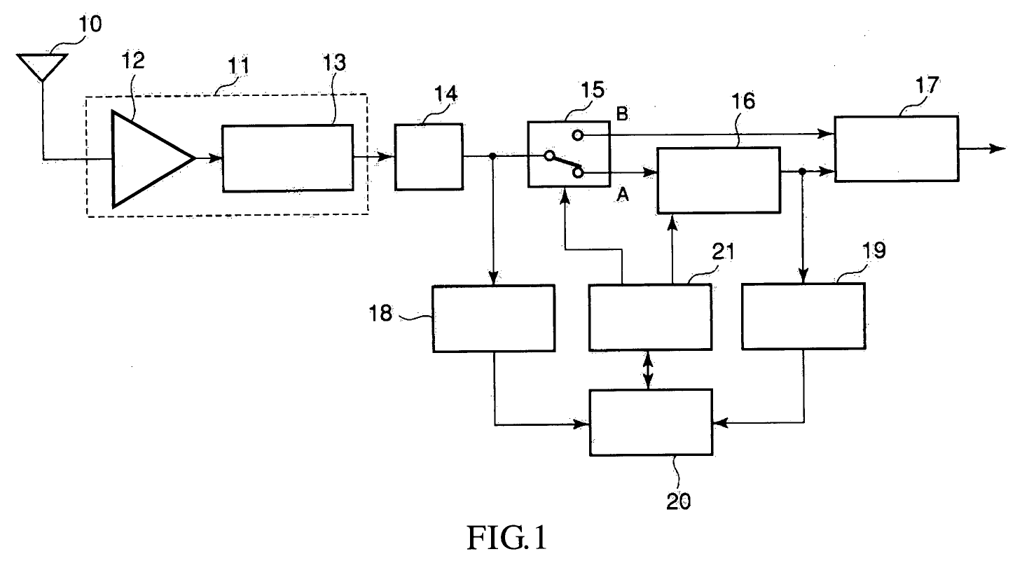

FIG. 1 illustrates the constitution of a radio receiver unit according to a first embodiment of the invention. RF signals are received by an antenna 10, and the thus received signals are output from the antenna 10. The received signals are input to a receiving circuit unit 11. The receiving circuit unit 11 includes a low-noise amplifier (LNA) 12 for amplifying the received signals up to a required level and an analog signal processing unit 13. The analog signal processing unit 13 includes a frequency converter for converting the received signals into analog base band signals and an analog filter for removing undesired waves that are produced accompanying the frequency conversion.

The analog base band signals output from the receiving circuit unit 11 are converted into digital base band signals through an A/D converter 14. The digital base band signals are input to a switch 15, and are changed over to be input to an FIR filter 16 through which interference waves are removed or to be input to a digital demodulating unit 17.

That is, the transmission path of digital base band signals from the A/D converter 14 to the digital demodulating unit 17 is a path that passes through the FIR filter 16 (hereinafter referred to as via-filter path) in a state where the switch 15 is connected to the side A in the drawing or is a path without passing through the FIR filter 16 (hereinafter referred to as direct path) in a state where the switch 15 is connected to the side B in the drawing. Here, the FIR filter 16 is used for removing the interference waves. It is, however, also allowable to use any other digital filter.

When the radio receiver unit of this embodiment is, for example, a wireless terminal in the wireless LAN, the RF signals received by the antenna 10 contain desired waves and may, further, contain interference waves that are the factors deteriorating the reception characteristics as described above. To estimate the magnitude of the interference wave power, this embodiment is provided with two power measuring units 18 and 19, and an interference wave power estimating unit 20. The first power measuring unit 18 measures the power value of output signals of the A/D converter 14, and the second power measuring unit 19 measures the power value of output signals of the FIR filter 16. The power measuring units 18 and 19 measure the power value of the received signals of before passing through the FIR filter 16 and the power value of the received signals of after having passed therethrough, respectively.

The power values measured by the power measuring units 18 and 19 are given to the interference power estimating unit 20. The interference wave power estimating unit 20 estimates the magnitude (electric power) of interference wave power from the above two power values, and gives the estimated value to the control unit 21. The control unit 21 judges the estimated interference wave power, and controls the switch 15 and the FIR filter 16 depending upon the judged result.

FIG. 3 schematically illustrates the constitution of a wireless LAN to which the radio receiver unit of this embodiment can be applied. There are arranged a plurality of wireless access points (AP) 41 and 42 which are the base stations, and one or a plurality of wireless terminals (TE) 40. The wireless terminal 40 is capable of executing the communication by forming a suitable communication channel with respect to the access points 41 and 42. Here, the radio receiver unit of this embodiment can be applied to the wireless terminal 40.

Next, described below is the operation of the radio receiver unit according to the embodiment.

As described above, interference waves enter into the received signals output from the antenna 10. Here, however, interference waves are not necessarily existing at all times. Concretely speaking, if the radio receiving unit is a wireless terminal for the wireless LAN in compliance with, for example, IEEE 802.11a, the interference waves are formed by the signal waves of neighboring channels existing on a frequency axis 20 MHz above and below the channel on which desired waves are received.

In a step in which the received signals from the antenna 10 are converted into base band signals through the receiving circuit unit 11, the interference wave components are suppressed to a certain degree by the analog filter included in the analog signal processing unit 13 in the receiving circuit unit 11. The residual components of interference waves that are still contained in the output from the receiving circuit unit 11, are finally suppressed by the FIR filter 16 in the last stage.

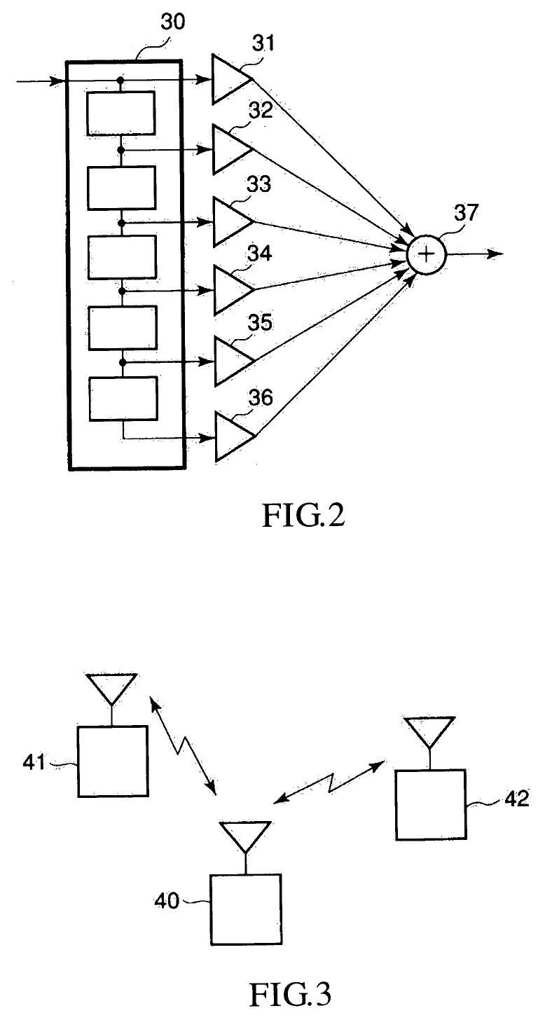

Referring to FIG. 2, the FIR filter 16 is constituted by a shift register 30 having a plurality of taps arranged maintaining a predetermined unit delay time interval as represented by Z⁻¹, multipliers 31 to 36 for multiplying the tap outputs of the shift register 30 by predetermined constants (called tap coefficients), and an adder 37 for obtaining the sum of output signals of the multipliers 31 to 36. Here, the tap coefficients multiplied by the multipliers 31 to 36 are the ones with which the FIR filter 16 acquire transmission characteristics of a low-pass filter as described in, for example, “Modulation/Demodulation of Digital Wireless Communication” (by Yoichi Saito, Academy of Electronic Information Communication, pp. 47-57).

Then, the FIR filter 16 realizes filter characteristics that sufficiently suppress the interference waves existing in the neighboring channels.

The FIR filter 16 shown in FIG. 2 includes the multi-stage shift register 30 that operates at a high speed and many multipliers 31 to 36, and, hence, consumes relatively large amounts of electric power among the elements constituting the radio receiver unit. In this embodiment, therefore, the interference wave power estimating unit 20 estimates the electric power of interference waves in a state where the switch 15 is connected to the side A as shown in FIG. 1, and the digital base band signals from the A/D converter 14 are input to the digital demodulating unit 17 through the FIR filter 16.

Concretely speaking, the interference wave power estimating unit 20 compares the power value P1 measured by the first power measuring unit 18 with the power value P2 measured by the second power measuring unit 19, and finds a ratio P1/P2 of the two or a difference P1-P2 between the two to estimate the electric power of interference waves. Namely, P1/P2 or P1-P2 is an estimated value of the interference wave power.

The control unit 21 compares P1/P2 or P1-P2 which is an estimated value and is a rough indication of the interference wave power with a threshold value TH1 or TH2, turns the filter 16 off by shutting off the power source for the FIR filter 16 when P1/P2?TH1 or when P1-P2?TH2, and connects the switch 15 to the side B from the side A. Then, the transmission path of the base band signals is changed over to the direct path, and the digital base band signals from the A/D converter 14 are directly input to the digital demodulating unit 17 without passing through the FIR filter 16.

That is, when the radio receiver unit has received desired waves only, no interference wave is contained in the received signals, and power values P1 and P2 of the received signals input to, and output from, the FIR filter 16 are not much different. However, a condition P1?P2 holds at all times due to the loss through the filter 16. Therefore, when P1/P2 is smaller than a threshold value TH1 or when P1-P2 is smaller than a threshold value TH2, it can be so regarded that no interference wave is contained or the interference wave power is very small. The condition where the interference wave power is very small includes a case where the interference waves are contained in the signals received by the antenna 10 but the interference wave components are suppressed to a sufficient degree by the analog filter in the receiving circuit unit 11.

The threshold values TH1 and TH2 can be theoretically determined from, for example, the transmission characteristics of the FIR filter 16, or can be experimentally determined from the comparison of when the radio receiver unit has received desired waves only with when the radio receiver unit has received interference waves positioned on the channels neighboring the desired waves in addition to receiving the desired waves.

The interference wave power estimating unit 20 may estimate the interference wave power at periodic timings or at non-periodic timings. Or, in other words, the control unit 21 may determine to cease the operation of the FIR filter 16 and to change the switch 15 over to the side B according to the estimated value of the interference wave power at periodic timings or non-periodic timings. In the wireless LAN, for example, the timing for estimating the interference wave power may be brought into synchronism with the control signals called beacon generated by an access point at a predetermined period, or the interference wave power may be estimated at a period specifically determined by the hardware of the radio receiver unit.

Instead of the above periodic timings, further, the interference wave power may be non-periodically estimated in cooperation with some operation of an upper layer specified by, for example, the MAC (medium access control) protocol specifications of IEEE 802.11. Concretely speaking, the MAC protocol specifications of IEEE 802.11a or IEEE 802.11 specify a time interval between the frames called SIFS (short interframe space).

During the period of SIFS, transmission or reception is effected by none of the wireless terminals that are communicating with the same access point in the wireless LAN, and no signal flows at all on the channel used by the access point, establishing a state which is very convenient for measuring the interference wave power on the neighboring channels. Therefore, interference wave power can be estimated during the period of SIFS. It has further been known that during the period of SIFS, no desired wave is contained in the signals received by the radio receiver unit which is a wireless terminal. Therefore, the interference wave power maybe estimated from the comparison of the power value measured by, for example, the power measuring circuit 18 with a predetermined threshold value that is so determined as to judge the magnitude of the interference wave power or the presence thereof.

The processing for estimating the interference wave power by the interference wave power estimating unit 20 and the processing for comparison and judgement by the control unit 20 based on the estimated value, are periodically conducted at the above-mentioned timings even after the operation of the FIR filter 16 is stopped, the switch 15 is connected to the side B and the signal transmission path to the digital demodulating unit 17 is changed over to the direct path.

When P1/P2 has exceeded the threshold value TH1 or when P1-P2 has exceeded the threshold value TH2, the control unit 21 so judges that the interference waves of large power are contained in the received signals, whereby the FIR filter 16 starts normally operating, the switch 15 is connected to the side A, and the signal transmission path to the digital demodulating unit 17 is changed over to the via-filter path.

It is desired that the control unit 21 judges whether the operation of the FIR filter 16 be discontinued, the switch 15 be connected to the side B, and the signal transmission path to the digital demodulating unit 17 be changed over to the direct path based on the estimated interference wave power, not simply relying on only one time of comparison and judgement of the electric power values by the power measuring units 18 and 19 but on the continuation of conditions in which it can be regarded that the interference wave power remains small over several times of comparison and judgement. In other words, it is desired that the control unit 21 discontinues the operation of the FIR filter 16 and changes the signal transmission path to the digital demodulating unit 17 over to the direct path when the condition of P1/P2?TH1 or P1-P2?TH2 has continued for a predetermined period of time.

Conversely, when the control unit 21 operates the FIR filter 16 and changes the signal transmission path over to the via-filter path, the signal transmission path may be readily changed over provided the condition in which the interference wave power can be regarded to be large (estimated interference wave power is greater than the threshold value) is satisfied even once. By adding the condition of hysteresis to the judgement by the control unit 21 as described above, it is allowed to stabilize the receiving condition.

According to this embodiment as described above, when it can be regarded that the power of interference waves existing near the frequency region is smaller than that of the desired waves, operating of the FIR filter 16 that consumes large amounts of electric power is stopped, so that the radio receiver unit as a whole consumes the electric power in small amounts yet satisfying a desired communication quality.

In FIG. 1, the interference wave power estimating units 18 and 19 are illustrated separately from the control unit 21 for easy comprehension. However, these functions may be imparted to the CPU and may be realized by the software processing.

### Second Embodiment

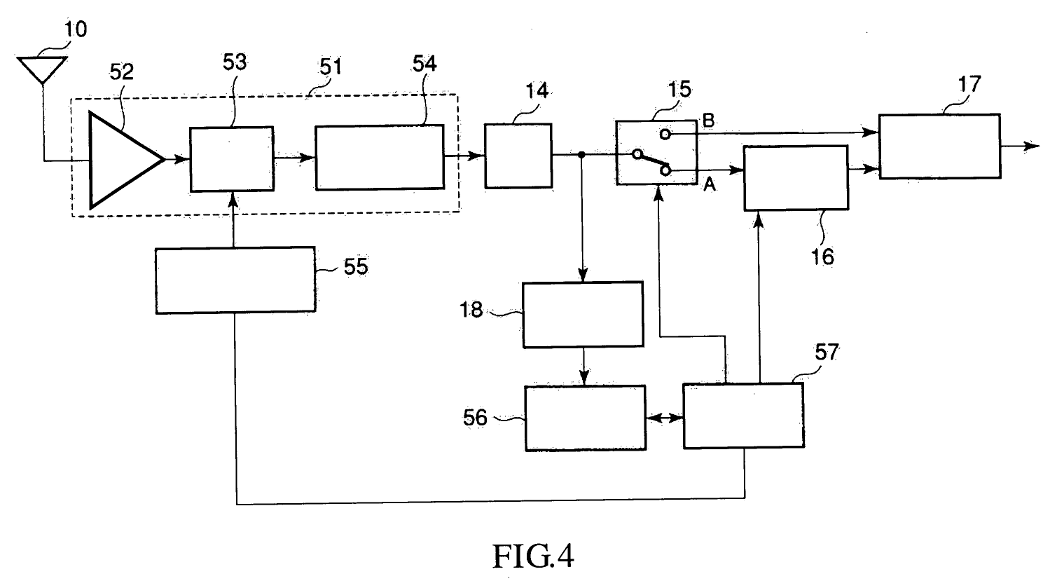

Next, the radio receiver unit according to a second embodiment of the invention will be described with reference to FIG. 4. In this embodiment, a receiving circuit unit 51 includes a low-noise amplifier (LNA) 52, a frequency converter 53 and an analog signal processing unit 54. The RF signals received by the antenna 10 contain desired waves as well as interference waves that are factors of deteriorating the reception characteristics like those of the first embodiment. The signals received by the antenna 10 are input to the receiving circuit unit 51, amplified through the low-noise amplifier 52, and are input to a frequency converter 53. The frequency converter 53 converts a frequency fi of a desired channel into a predetermined intermediate frequency fm. The frequency converter 53 is served with local signals of a frequency fc which makes ?fi−fc?=fm from a frequency synthesizer 55. The frequency fc is variable as the frequency synthesizer 55 is controlled by a control unit 57, and the frequency of the receiving channel can be changed over.

The received signals converted through the frequency converter 53 to possess the intermediate frequency fm are, then, converted into base band analog signals through an analog signal processing unit 54. In this step, the interference waves contained in the received signals are suppressed to a certain degree by the analog filter included in the analog signal processing unit 54. The residual components of interference waves that are still contained are finally suppressed by the FIR filter 16 in the last stage.

Like in the first embodiment, the analog base band signals output from the receiving circuit unit 51 are converted into digital base band signals through the A/D converter 14, and are changed over to be input to the FIR filter 16 or to the digital demodulating unit 17 being switched by the switch 15. That is, the transmission path of digital base band signals to the digital demodulating portion 17 is changed over to the via-filter path and to the direct path by the switch 15. The FIR filter 16 is provided for suppressing the interference wave components, and is constituted as shown in, for example, FIG. 2 like in the first embodiment. Through the via-filter path, the interference waves such as signals of the neighboring channels contained in the digital base band signals are suppressed to a sufficient degree through the FIR filter 16. The digital base band signals are then input to the digital demodulating unit 17 and are demodulated.

The digital base band signals output from the A/D converter 14 are further input to the power measuring unit 18 where the electric power value is measured. The power value measured by the power measuring unit 18 is given to the interference wave power estimating unit 56. In this embodiment, the interference wave power estimating unit 56 estimates the magnitude (power value) of electric power of the interference waves from the power value measured by the power measuring unit 18, and gives the estimated value to the control unit 57. The control unit 57 judges the estimated value of interference wave power given from the interference wave power estimating unit 56 based on a threshold value, and controls the switch 15 and the FIR filter 16 depending upon the judged result.

In this embodiment, the interference wave power is estimated in a state where the receiving channel is temporarily changed over to a channel neighboring the channel of the desired waves. In the case of a wireless terminal for the wireless LAN in compliance with the IEEE 802.11a described above, for example, there exist neighboring channels 20 MHz above and below the receiving channel of the desired waves on a frequency axis, and the signal waves of these neighboring channels become interference waves. Upon changing over the output frequency fc of the frequency synthesizer 55 at predetermined timings, the control unit 57 changes the receiving channel over to neighboring channels existing at frequencies 20 MHz higher than and lower than the center frequency of the desired channel.

In a state where the receiving channel is changed over to the neighboring channels, the desired waves are not contained in the received signals. When the neighboring channels are used for the communication, there exist the interference waves only. Therefore, the power measuring unit 18 measures the power value of interference waves. The power value measured by the power measuring unit 18 is input to the interference wave power estimating unit 56. In a state where the receiving channel is changed over to the neighboring channel being instructed by the control unit 57, the interference wave power estimating unit 56 reads the power value measured by the power measuring unit 18 and outputs it as an estimated value P of interference wave power.

The control unit 57 compares the estimated value P obtained by the interference wave power estimating unit 56 with, for example, a given threshold value TH and so judges, when the estimated value P is smaller than the threshold value TH, that the neighboring channel has not been used for the communication and no interference wave is existing or the interference wave power is very small. The condition where the interference wave power is very small includes a case where the interference waves are contained in the signals received by the antenna 10 but the interference wave components are suppressed to a sufficient degree by the analog filter in the receiving circuit unit 51.

When it is judged that there exists no interference wave or the interference wave power is very small, the control unit 57 shuts off the power source of the FIR filter 16 to turn the filter 16 off and further changes the switch 15 over to the side B from the side A, i.e., changes the base band signal transmission path over to the direct path. Then, the digital base band signals from the A/D converter 14 are directly input to the digital demodulating unit 17 without passing through the FIR filter 16.

If further concretely described, the control unit 57 changes the output frequency fc of the frequency synthesizer 55 from a state satisfying ?fi−fc?=fm where a desired channel is the receiving channel over to a state satisfying ?fᵢ₊₁-fc?=fm or ?fᵢ₋₁−fc?=fm where a neighboring channel is the receiving channel at periodic or non-periodic predetermined timings. Here, fᵢ₊₁ and fᵢ₋₁ are center frequencies of the neighboring channels existing above and below the desired channel. Simultaneously with the change-over of the receiving channel, the control unit 57 compares the estimated value P of interference wave power obtained by the interference wave power estimating unit 56 from the power value measured by the power measuring unit 18 with the threshold value TH.

If the result of comparison and judgement turns out to be the state satisfying ?fᵢ₊₁−fc?=fm or ?fᵢ₋₁−fc?=fm and P?TH, the control unit 57 regards that the power of interference waves is small, stops the FIR filter 16 from operating, connects the switch 15 to the side B, and changes the signal transmission path to the digital demodulating unit 17 over to the direct path without passing through the FIR filter 16. Thereafter, the control unit 57 returns the output frequency fc of the frequency synthesizer 55 so that the receiving channel becomes the desired channel. Here, the threshold value TH is determined to be an upper-limit value of power value with which it can be so regarded that no signal is existing in the neighboring channels.

According to this embodiment, measurement of the electric power may be to learn whether signals that become interference waves are existing in the neighboring channels. Therefore, the power measuring unit 18 needs not necessarily be provided at the position of FIG. 4 but may measure the power value of analog signals before the A/D converter 14. The power value of signals may be measured in the signal path from the output of the FIR filter 16 to the input of the digital demodulating unit 17 in a state where the FIR filter 16 is in operation, to enhance the precision of measurement of signal power on the neighboring channels.

The timing at which the interference wave power estimating unit 56 estimates the interference wave power and a timing at which the control unit 57 stops the FIR filter 16 from operating and judges whether the switch 15 be changed over to the side B in response to the estimated value of interference wave power, must be such timings at which, basically, no communication is taking place between the access point and the wireless terminal on the desired channel when the radio receiver unit is a wireless terminal in the wireless LAN.

The timings may be those timings in a time zone of a period specifically determined by the hardware of the radio receiver unit and satisfying the conditions in which no communication is effected between the access point and the wireless terminal on the desired channel. Or, as described in the first embodiment, the timings may be non-periodic timings in cooperation with some operation of an upper layer specified by the MAC protocol specifications of IEEE 802.11.

A concrete example of the latter case may be the above-mentioned SIFS specified by the MAC protocol specifications of IEEE 802.11a or IEEE 802.11.

On the other hand, IEEE 802.11h (European specifications) is introducing a dynamic frequency control function, and one of which is a function for measuring the power of each channel. Use of this function makes it possible to judge the presence of interference waves in the operation of an upper layer in the wireless LAN protocol. The dynamic frequency control function according to IEEE 802.11h measures the power of the channels while changing over the output frequency of the frequency synthesizer 55 in the same manner as the one described in this embodiment. According to the specification of IEEE 802.11h, the electric power is measured prior to conducting the communication and when the quality of communication is deteriorated, in order to search empty channels and the channels free of neighboring channels that are being used.

Therefore, when the wireless transmitter/receiver unit of this embodiment is a wireless terminal in the wireless LAN specified by IEEE 802.11h, the interference wave power estimating unit 56 may estimate the interference wave power based on the power value measured by the power measuring unit 18 at a timing of either prior to starting the communication or when the communication quality is deteriorated, and the control unit 57 may compare the estimated value P with the threshold value TH to judge whether there is no interference wave or the interference wave power is very small. When there is no interference wave or the interference wave power is very small as a result of judgement, the control unit 57 shuts off the power source for the FIR filter 16 to turn the filter 16 off, and connects the switch 15 to the side B from the side A to change the base band signal transmission path over to the direct path.

Prior to starting the communication, further, the interference wave power is estimated by the interference wave power estimating unit 56 based on the power value measured by the power measuring unit 18 to thereby judge whether the neighboring channels are being used. When the neighboring channels are not being used, the FIR filter 16 is turned off. When the communication quality is deteriorated, it is regarded that the neighboring channel is being used, and the FIR filter 16 may be turned on.

The processing for estimating the interference wave power by the interference wave power estimating unit 56 accompanying the change-over of output frequency of the frequency synthesizer 55 and the processing for comparison and judgement by the control unit 57 based on the estimated value, are periodically conducted at the above-mentioned timings even after the operation of the FIR filter 16 is discontinued, the switch 15 is connected to the side B and the signal transmission path to the digital demodulating unit 17 is changed over to the direct path.

If concretely described, the output frequency fc of the frequency synthesizer 55 is changed from a state satisfying ?fi−fc?=fm where a desired channel is the receiving channel over to a state satisfying ?fᵢ₊₁−fc?=fm or ?fᵢ₋₁−fc?=fm where a neighboring channel is the receiving channel. Simultaneously with the change-over of the receiving channel, the control unit 57 compares the estimated value P of interference wave power obtained by the interference wave power estimating unit 56 from the power value measured by the power measuring unit 18 with the threshold value TH.

If the result of comparison turns out to be at least either ?fᵢ₊₁−fc?=fm or ?fᵢ₋₁−fc?=fm and P ? TH, the control unit 57 regards that the power of interference waves is large, starts operating the FIR filter 16, and, further, connects the switch 15 to the side A, and changes the signal transmission path to the digital demodulating unit 17 over to the pass passing through the FIR filter 16.

It is desired that the control unit 57 judges whether the operation of the FIR filter 16 be discontinued, the switch 15 be connected to the side B, and the signal transmission path to the digital demodulating unit 17 be changed over to the direct path based on the estimated interference wave power, not simply relying on only one time of comparison and judgement of the electric power values by the power measuring unit 56 but on the continuation of conditions in which it can be regarded that the interference wave power remains small over several times of comparison and judgement.

Conversely, when the control unit 57 operates the FIR filter 16 and changes the signal transmission path over to the via-filter path, the signal transmission path may be readily changed over provided the condition in which the interference wave power can be regarded to be large (estimated interference wave power is greater than the threshold value) is satisfied even once. By adding the condition of hysteresis to the judgement by the control unit 57 as described above, it is allowed to stabilize the receiving condition.

According to this embodiment, too, as described above, when it can be regarded that the power of interference waves is small like in the first embodiment, the FIR filter 16 that consumes large amounts of electric power is stopped operating, so that the radio receiver unit as a whole consumes the electric power in small amounts yet satisfying a desired communication quality.

In FIG. 4, the interference wave power estimating unit 56 is illustrated separately from the control unit 57 for easy comprehension. However, these functions may be imparted to the CPU and may be realized by the software processing.

### Third Embodiment

Next, a third embodiment of the invention will be described. The first and second embodiments were provided with a mechanism for estimating the power value of interference waves positioned close to a desired waves in the frequency domain, which, however, needs not necessarily be provided. When, for example, it has been known that no interference wave is existing from the situation and environment where the radio receiver unit is installed, the operation of the FIR filter 16 may be discontinued upon receipt of an instruction from the user.

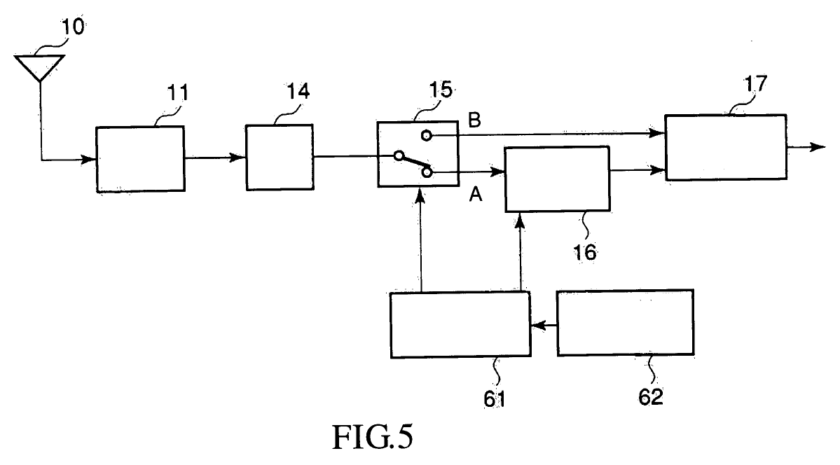

FIG. 5 is a diagram illustrating the constitution of the radio receiver unit according to a third embodiment of the invention based on the above idea. The same portions as those of FIG. 1 are denoted by the same reference numerals. In this embodiment, a mode selection switch 62 is connected to a control unit 61. The mode selection switch 62 is the one for changing the operation mode of the radio receiver unit over to a normal power consumption mode or to a low power consumption mode, and is provided at a suitable portion of the radio receiver unit so as to be operated by the user.

When the low power consumption mode is selected by the mode selection switch 62, the control unit 61 shuts off the power source for the FIR filter 16 to turn the filter 16 off, and changes the switch 15 over to the side B from the side A, i.e., changes the base band signal transmission path over to the direct path.

In a wireless LAN installed in a household, for example, when only one wireless LAN card is used in a radio receiver unit or when there is only one access point, the interference wave is not existing. Therefore, there is no need of removing the interference wave components by the FIR filter 16. In such a situation, therefore, the mode selection switch 62 is operated to assume the low power consumption mode in which the FIR filter 16 is not operated to avoid wasteful power consumption.

It is also allowable to put the constitution of this embodiment into practice in combination with the above first or second embodiment. Namely, the mode selection switch 62 is connected to the control unit 21 shown in FIG. 1 or to the control unit 57 shown in FIG. 4 to add an option for manually selecting the mode. In this case, for controlling the FIR filter 16 and the switch 15, it is quite arbitrary to place priority to either the control based on the interference wave power estimation in the first or second embodiment or on the control based on the mode selection.

The above-mentioned embodiments have chiefly dealt with the cases where the invention was applied to the wireless LAN. The invention, however, is in no way limited thereto and can be applied to radio receiver units, in general. Besides, the concrete constitutions can be modified in a variety of ways.

The invention is not limited to the above-mentioned embodiments and can be put into practice while varying the constituent elements in a range without departing from the gist thereof. By suitably combining a plurality of constituent elements disclosed in the embodiments, further, a variety of inventions can be formed. For example, some constituent elements may be omitted from the whole constituent elements disclosed in the embodiments. Further, constituent elements in different embodiments may be suitably combined together.

According to this invention as described above in detail, there is provided a radio receiver unit which, when the power of interference waves contained in the received RF signals is small, discontinues the operation of the interference wave-removing filter to effectively decrease the consumption of electric power yet maintaining the quality of reception for the desired waves.

What is claimed is:

1. A radio receiver unit comprising:
receiving means for receiving RF (radio frequency) signals;
a filter arranged in a stage succeeding said receiving means and is capable of being turned on or off;
estimating means for estimating the magnitude of electric power of interference waves contained in said RF signals and for producing an estimated value corresponding to the magnitude of said electric power; and
control means for turning said filter off during a period in which said estimated value is smaller than a threshold value.

2. A radio receiver unit comprising:
receiving means for receiving RF signals;
a filter arranged in a stage succeeding said receiving means and is capable of being turned on or off;
demodulating means for demodulating first received signals of before passing through said filter or for demodulating second received signals after having passed through said filter;
estimating means for estimating the magnitude of electric power of interference waves contained in said RF signals and for producing an estimated value corresponding to said magnitude; and
control means for so controlling said filter as to be turned off during a period in which said estimated value is smaller than a threshold value.

3. A radio receiver unit according to claim 1 or 2, wherein said estimating means effects the estimation by comparing and judging the power values of said first received signals and of said second received signals.

4. A radio receiver unit according to any one of claims 1 to 3, wherein said estimating means effects the estimation periodically.

5. A radio receiver unit according to any one of claims 1 to 4, wherein said estimating means effects the estimation during a period in which said receiving means is receiving RF signals without containing said desired waves.

6. A radio receiver unit according to claim 1 or 2, wherein said control means turns said filter off when a period in which said estimated value is smaller than the threshold value continues for a predetermined period of time.

7. A radio receiver unit according to claim 1 or 2, wherein said receiving means has a function for receiving said RF signals corresponding to a receiving channel selected out of a plurality of channels, and said estimating means effects the estimation upon temporarily receiving RF signals corresponding to a second channel in a frequency band neighboring a first channel in which said desired waves exist among said plurality of channels.

8. A radio receiver unit according to claim 7, wherein said radio receiver unit is a wireless terminal used in a wireless LAN system that includes a base station and the wireless terminal for effecting the communication with said base station, and said estimating means effects the estimation prior to starting the communication or when the communication quality is deteriorated.

9. A radio receiver unit capable of changing the operation mode over to a normal power consumption mode or to a low power consumption mode in which the consumption of electric power is small during the operation, comprising:
receiving means for receiving RF signals that contain desired waves;
a filter arranged in a stage succeeding said receiving means and is capable of being turned on or off; and
control means for turning said filter off during said low power consumption mode.

10. A radio receiver unit capable of changing the operation mode over to a normal power consumption mode or to a low power consumption mode in which the consumption of electric power is small during the operation, comprising:
receiving means for receiving RF signals;
a filter arranged in a stage succeeding said receiving means;
demodulating means for demodulating first received signals of before passing through said filter or for demodulating second received signals after having passed through said filter; and
control means for so controlling said filter as to be turned off during said low power consumption mode.

11. A radio receiver unit according to any one of claims 1 to 7, 9 and 10, wherein said radio receiver unit is a wireless terminal used in a wireless LAN system that includes a base station and the wireless terminal for effecting the communication with said base station.
